(19) United States
(12) Patent Application Publication
(10) Pub. No.: US 2007/0114298 A1
(43) Pub. Date: May 24, 2007

(54) Hurricane Abatement Method and System

(75) Inventor: Dennis Robert O'Keefe, San Diego, CA (US)

Correspondence Address: GODO CONSULTING, 5045 PARK WEST AVE., SAN DIEGO, CA, 92117, US

(73) Assignee: GODO CONSULTING, San Diego, CA (US)

(21) Appl. No.: 11/555,607

(22) Filed: Nov. 1, 2006

Related U.S. Application Data
(60) Provisional application No. 60/734,596, filed on Nov. 8, 2005.

(51) Int. Cl. A01G 15/00

(52) U.S. Cl. 239/2.1; 239/14.1

(57) ABSTRACT

Methods and systems are described for the abatement of hurricanes and other atmospheric disturbances. The methods and systems comprise the delivery of various coolants in either their liquid, gaseous, or solid states and applying such coolants to energy feeding regions of the atmospheric disturbance identified by analytical modeling. The coolants are both cryogenic and non cryogenic. In addition to cooling, the cryogenic coolants create wind-sheer and large frozen objects in mesoscale model identified updrafts of an atmospheric disturbance from high altitudes down to sea level. All coolants bring about the abatement of the hurricane by the dehydration of the moisture laden air, the disruption of the stability of the hurricane winds, and the preemption of work by the hurricane's heat engine prior to land fall.

### CROSS-REFERENCE TO RELATED APPLICATION

The present patent application claims priority to U.S. Provisional Patent Application No. 60/734,596, filed Nov. 8, 2005, and entitled “Hurricane Abatement Method and System,” the entire disclosure of which is incorporated by reference herein.

### BACKGROUND OF THE INVENTION

1. Field of Invention

This invention relates to atmospheric disturbance abatement and, more specifically, to the abatement of hurricanes. In particular, methods and systems are utilized in ways in which coolants are applied to the energy feeding regions of an atmospheric disturbance. These methods and systems serve to cool, dehydrate, disrupt wind patterns, and to remove energy from an atmospheric disturbance.

2. Description of Related Art

In scientific terms a hurricane is a heat engine operating as a Carnot Cycle. It extracts moisture from the surface of the ocean at its ambient warmer temperature and condenses it as it rises to cooler altitudes thereby adding heat to the hurricane and then expelling this heat into the upper atmosphere at cooler ambient temperatures. The warmer the ocean surface and the cooler the upper atmospheric conditions the more the hurricane is able to convert energy into wind velocity and the conditions to perform work which, in its case, is the destruction or damage of anything that gets in its path. This is particularly true over land masses where the hurricane's energy is dissipated through the destruction of natural objects such as trees and manmade objects such as power lines, houses, bridges, automobiles, and boats. Human lives are placed in peril from the passage of such a storm.

The seeding of clouds to bring about precipitation has been known for many years, however, the seeding of hurricanes has been limited, and without recent mesoscale modeling studies of hurricanes, has been a random treatment method. In addition, some of the seeding techniques used, and suggested for use, are not benign to the environment.

The earliest report of seeding a hurricane is in 1947 where dry ice (solid carbon dioxide) was dropped onto a hurricane in a Government sponsored program named Project Cirrus. In that trial, the hurricane was seen to abruptly change course, but this change could not be directly attributed to the seeding effect. Without present day mesoscale models of hurricanes, the seeding of a hurricane in these early attempts was random and did not target specific energy feeding regions of the hurricane.

In one known discussion in a webpage article it is cited that substances with temperatures less than −40 degrees Celsius (e.g. Solid C0₂ [“dry ice”] pellets, liquid CO₂, liquid propane, and liquid nitrogen) can be dropped from airplanes into the top of clouds, to induce formation of ice crystals.

Liquid propane is an atmospheric pollutant and is dismissed as an environmentally friendly seed substance. In addition, being a combustible chemical, its use would be particularly questionable in storms with electrical activity.

Simply stating the use of liquid nitrogen as a substance to induce the formation of ice crystals does not address the use of this cryogenic coolant in its liquid, vapor and solid states for targeting the energy feeding regions of an atmospheric disturbance.

Aimed at steering and/or modifying hurricanes, seeding the eye walls of hurricanes with silver iodide has been tried in a government project named Storm Fury. The results of that study were inconclusive in that the method seemed to effect a hurricane in one instance and not in another and it never could be concluded that the method was effective. Also, silver iodide is not a chemical benign to the environment.

Another disclosed method places a thin partially polymerized thin film of material at the surface of the ocean in the path of a hurricane. Such a monolayer thick film could be a surfactant. This method has the effect of reducing the surface tension in water and stopping droplets from forming—perhaps preventing a hurricane from developing. This method is rendered less effective by wave motion breaking up the film prior to the arrival of the hurricane. Also, to date, a thin film material has not been found which is benign to the environment.

An additional disclosed method is one which potentially saps hurricanes of their moisture driven potential. This method uses moisture absorbing solids dropped by aircraft into the eye wall of a rapidly revolving tropical storm to weaken or destroy it. This method leaves a deposit of solid powders or gelatinous materials which is not benign to the environment.

In another disclosure, a network of microwave beaming satellites has been proposed to literally take the wind out of hurricanes. This method, if it would indeed work, would not be available for many years and the safety problems associated with its use would seem to render it nonviable.

### SUMMARY OF THE INVENTION

The present invention overcomes these and other deficiencies of the prior art by utilizing hurricane modeling studies to target the cooling of the energy feeding regions of a hurricane. Any portion of the hurricane may be treated by the present method, but from recent hurricane modeling results it would seem most effective to treat specific portions of the eye wall where initiating updraft regions of high moisture content are present. This invention would allow the treatment of regions of the hurricane at different altitudes within the identified updraft regions.

The material used for cooling is in liquid, vapor, or solid form depending on the desired effect. The coalescence of moisture into large water droplets, the absorption of moisture, the formation of large environmentally benign objects such as hailstones, and imposed wind shear all result from the implementation of the methods of the present invention. Imposed wind shear in the present invention is accomplished either by the formation of large frozen objects such as hailstones or the insertion of large weighty pieces of solid coolant into the atmospheric disturbance.

The cooling methods of this invention are either entirely benign or of very low impact to the environment. In addition to being benign to the environment, one coolant (cryogenic liquid, solid, or gaseous air) does not perturb the normal ambient gaseous composition other than the moisture content of the atmosphere in the region where it is applied.

In an embodiment of the invention, a method for abating an atmospheric disturbance comprises the steps of identifying an energy feeding region of the atmospheric and applying the coolant to the atmospheric disturbance. The identification of the energy feeding region of the atmospheric disturbance is obtained from an analytical model of the atmospheric disturbance. The coolant can be cryogenic liquid air, cryogenic air vapor, cryogenic solid air, cryogenic liquid nitrogen, cryogenic nitrogen vapor, cryogenic solid nitrogen, liquid carbon dioxide, carbon dioxide vapor, solid carbon dioxide (dry ice), cold liquid water, cold water vapor, and solid water (ice), and any combination of these. Cryogenic air is benign to the environment and does not perturb the normal ambient gaseous composition other than the moisture content in the region of the atmosphere to which it is applied.

The term atmospheric disturbance refers to any number of atmospheric disturbances including, but not limited to, a tropical depression, a tropical storm, a hurricane, a typhoon, a tornado, a rainstorm, a snow storm, a lightning storm, a warm frontal system, and any combination of these.

The step of delivering the coolants can be by aircraft, ship, barge, remotely controlled aircraft, remotely controlled ship, remotely controlled barge, and any combination of these.

The energy feeding region of the atmospheric disturbance may be a thermal updraft and this thermal updraft may be an initiating thermal updraft feeding energy to the atmospheric disturbance. In particular, the initiating thermal updraft may be a thermal updraft formed at the downtilt-right side of a hurricane.

The target altitude of the delivery of the coolant can be controlled by the choice of flow of vapor or liquid coolant and by the size and weight of the pieces of solid coolant and the application of the coolant can be by exposing, pouring, spraying, dropping, and any combination of these.

In another embodiment of the invention, a method for abating an atmospheric disturbance comprises the steps of manufacturing a coolant, delivering said coolant to the atmospheric disturbance, and applying the coolant to an energy feeding region of the atmospheric disturbance.

In another embodiment of the invention, a method for abating an atmospheric disturbance comprises the steps of loading a cryogenic coolant onto a vehicle and delivering the vehicle loaded with the cryogenic coolant to the atmospheric disturbance. The vehicle can be an aircraft, a ship, a barge, a remotely controlled aircraft, a remotely controlled ship, a remotellede , an d any combination of these.

In another embodiment of the invention, a system comprises a delivery vehicle and a means for discharging a cryogenic coolant into an atmospheric disturbance. The delivery vehicle can be an aircraft, a ship, a barge, a remotely controlled aircraft, a remotely controlled ship, a remotely controlled barge, and any combination of these. The cryogenic coolant is selected from the group consisting of a cryogenic liquid, cryogenic vapor, cryogenic solid, and any combination of these.

The foregoing, and other features and advantages of the invention, will be apparent from the following, more specific description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates a transport system for air lifting the coolant to the region of a hurricane eyewall according to an embodiment of the invention

FIG. 2 is a cut-away sketch of the coolant transport aircraft showing the air drop of a large slug of cryogenic liquid according to an embodiment of the invention.

FIG. 3 is a cut-away sketch of the coolant transport aircraft showing the air drop of streams of cryogenic liquid according to an embodiment of the invention.

FIG. 4 is a cut-away sketch of the coolant transport aircraft showing an airlift release of cryogenic vapor according to an embodiment of the invention.

FIG. 5 is a cut-away sketch of the coolant transport aircraft showing an airlift drop of a large cylindrical monolith of coolant solid according to an embodiment of the invention.

FIG. 6 is a cut-away sketch of the coolant transport aircraft showing an airlift drop of pieces of coolant solid according to an embodiment of the invention.

### DETAILED DESCRIPTION OF THE PREFFERED EMBODIMENTS

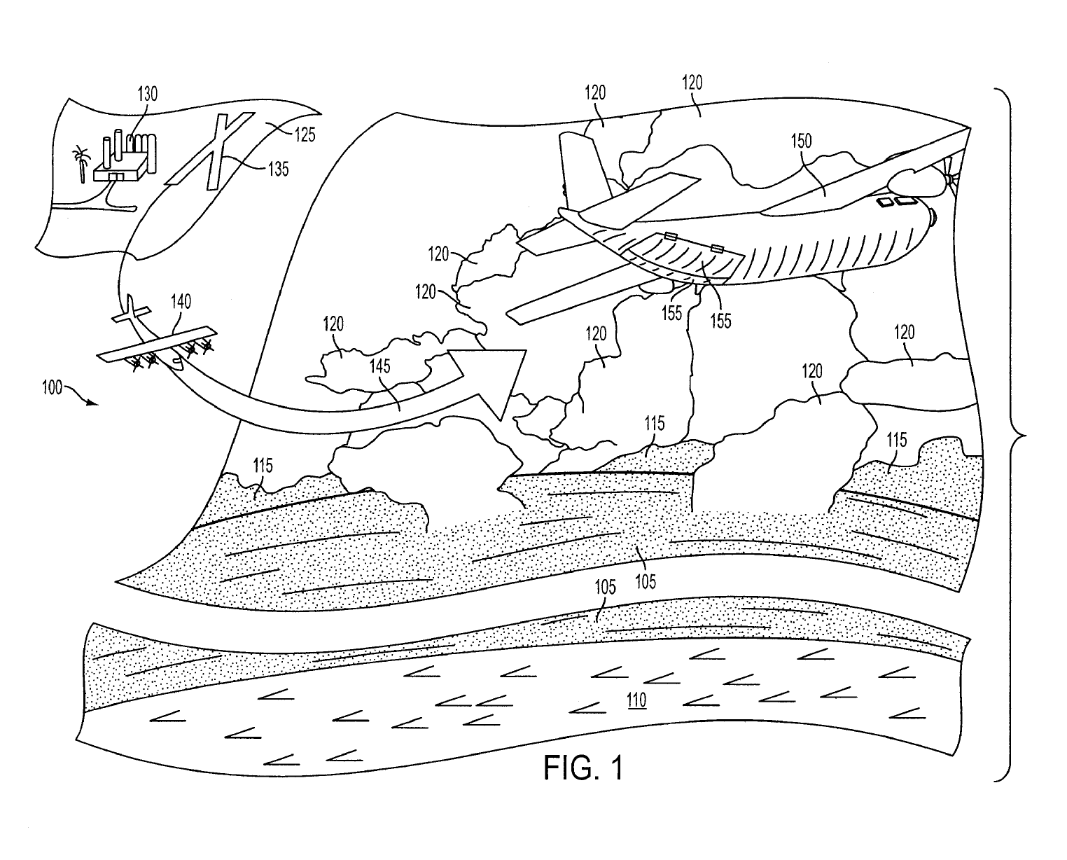

Preferred embodiments of the present invention and their advantages may be understood by referring to FIGS. 1-6 wherein like reference numerals refer to like elements. The accompanying Figures specifically illustrate the treatment of a hurricane, but the method and system can be used to treat any atmospheric disturbance including, but no limited to, a tropical depression, a tropical storm, a hurricane, a typhoon, a tornado, a rainstorm, a snow storm, a lightning storm, a warm frontal system, and any combination of these.

FIG. 1 illustrates an airlift system 100 for transporting coolant to the eyewall of a hurricane according to an embodiment of the invention. The figure depicts the eyewall of a hurricane 105 with the ocean surface 110 in the hurricane eye. Also shown is a portion of the top of the cylindrical eyewall 115. The reference numeral 120 depicts clouds. A land mass 125 remote from the hurricane, for example, on the West Coast of Africa, the East Coast of the United States, or an island in the Caribbean, has a cryogenic liquid or solid manufacturing plant 130 and an airstrip 135. The airstrip 135 is where the flights of the cargo drop aircraft may take off and land. An aircraft 140 taking off from the airstrip 135 is shown following the flight path 145 to the region of the hurricane where the airdrops are taking place from an aircraft 150. Cargo doors mounted in the aft portion of the aircraft are depicted as 155.

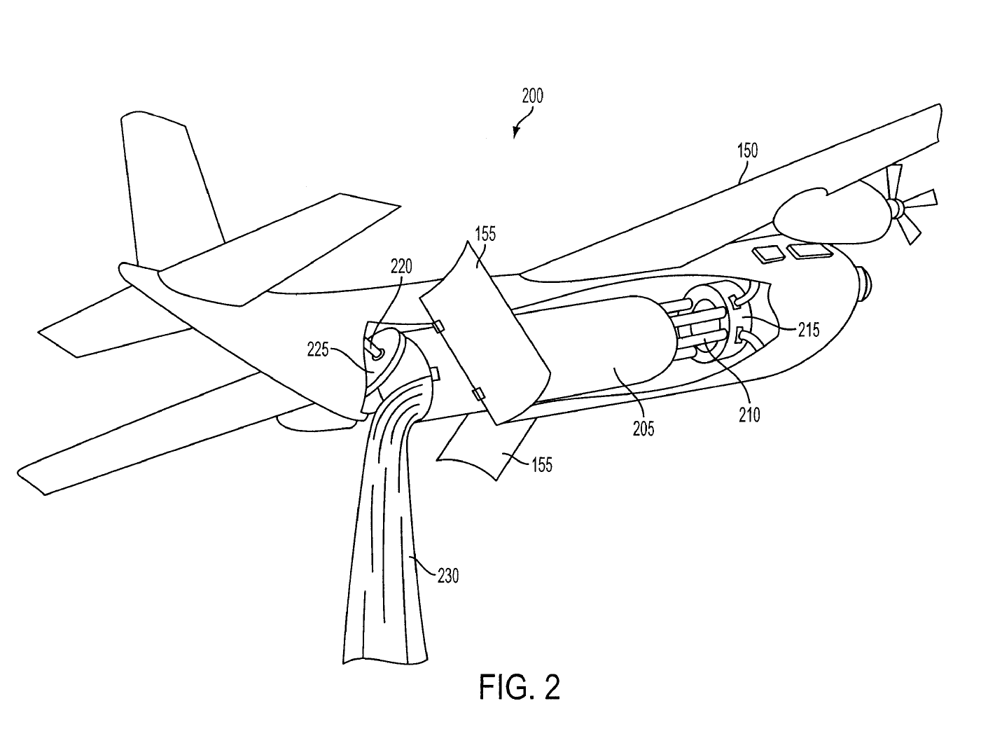

FIG. 2 shows a cargo airdrop system 200 according to an embodiment of the invention for an aircraft 150 at the drop point with its aft cargo doors 155 opened and the insulated tank 205 containing a cryogenic liquid 230 pushed aft on rails (not shown) internal to the aircraft fuselage. The tank 205 is pushed by a telescoping hydraulic actuator 210 with hydraulic fluid supplied by the pump unit 215. A pneumatic actuation could also be used in place of the hydraulic system. A separate hydraulic mechanism 220 opens and closes door 225 allowing the release of the cryogenic liquid 230 and also serves as a splash shield to protect the aft portion of the aircraft and its control mechanisms. The quick release slug pour of a tank full of cryogenic liquid is depicted as 230. Cargo aircraft would transport the cryogenic liquid in insulated tanks (dewars) such as used at semiconductor industrial facilities and hospitals. The outer dimensions of the largest of these present day available tanks are 10 feet 2 inches in diameter by 36 feet 2 inches long weighing about 148,000 pounds when empty. Each such tank holds 13,000 gallons of liquid air or liquid nitrogen which is about 87,200 pounds in weight. There is no restriction on whether such tanks could be increased or decreased in size depending on the load capacity of the drop aircraft chosen.

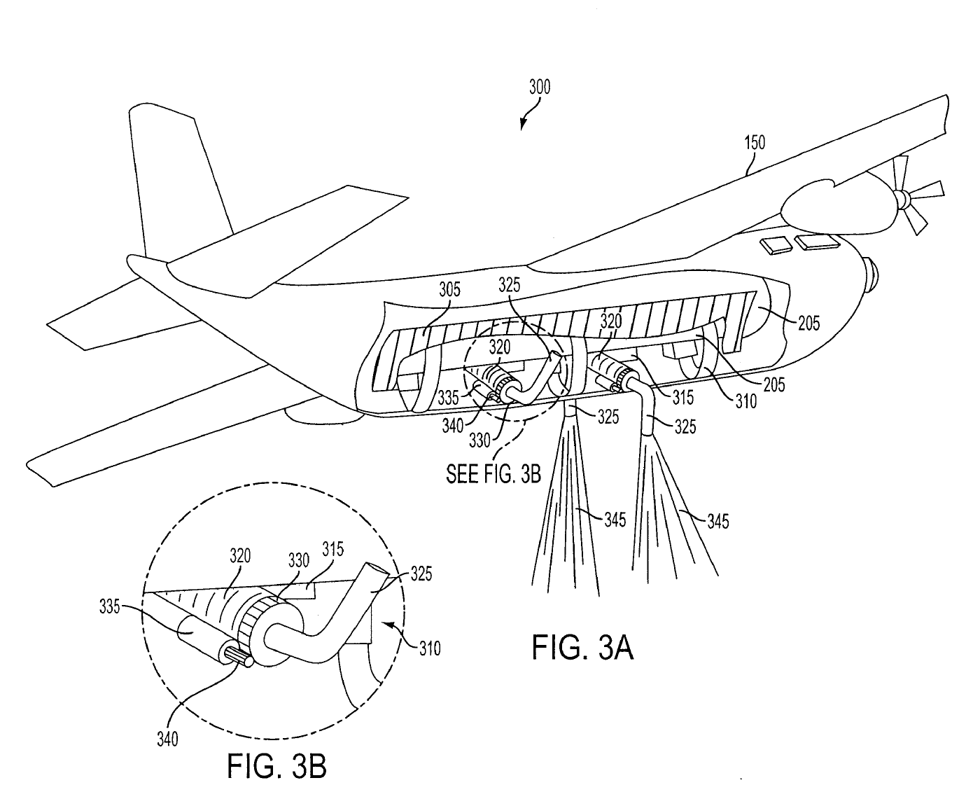

FIG. 3(a) shows a cargo airdrop system 300 according to an embodiment of the invention for an aircraft 150 at the drop point with its cargo doors 305 opened and a fixed insulated tank 205 containing the cryogenic liquid internal to the aircraft fuselage. FIG. 3(b) is an inset drawing showing the details of a proposed mechanism for rotating coolant delivery pipes 325 inside and outside the fuselage of the aircraft. The cargo doors 305 in this embodiment are on the underside of the aircraft in much resemblance to “bomb bay” door. Load bearing struts 310 such as depicted serve to maintain the integrity of the aircraft airframe and hold the insulated cryogenic tank 205 in place. As shown, the cryogenic liquid is released from the cargo aircraft by multiple large cryogenic valves 315 such as those used by NASA for delivering liquid hydrogen and liquid oxygen to rocket engines. These valves are placed on the underside of the insulated tank connected to a pipe manifold 320 which is laterally positioned with regard to the length dimension of the aircraft. There can be several of these pipe manifolds 320 along the length of the aircraft, but for illustrative purposes, only two are shown in the diagram. At each end of the pipe manifold is a rotatable pipe 325 and external gear assembly 330. A motor 335 having a geared shaft 340 meshes with the external pipe gear to rotate the elbowed delivery pipe 325 in or out of the confines of the aircraft. Delivery pipe 325 at a forward location on the aircraft is shown rotated external to the aircraft for the utility of applying the coolant. Delivery pipe 325 at an aft location on the aircraft is shown rotated internal to the aircraft. All delivery pipes on the aircraft can be deployed internal to the fuselage for takeoff and landing. The downward sprays of cryogenic liquid 345 from both sides of the aircraft originating from the same manifold 320 are shown.

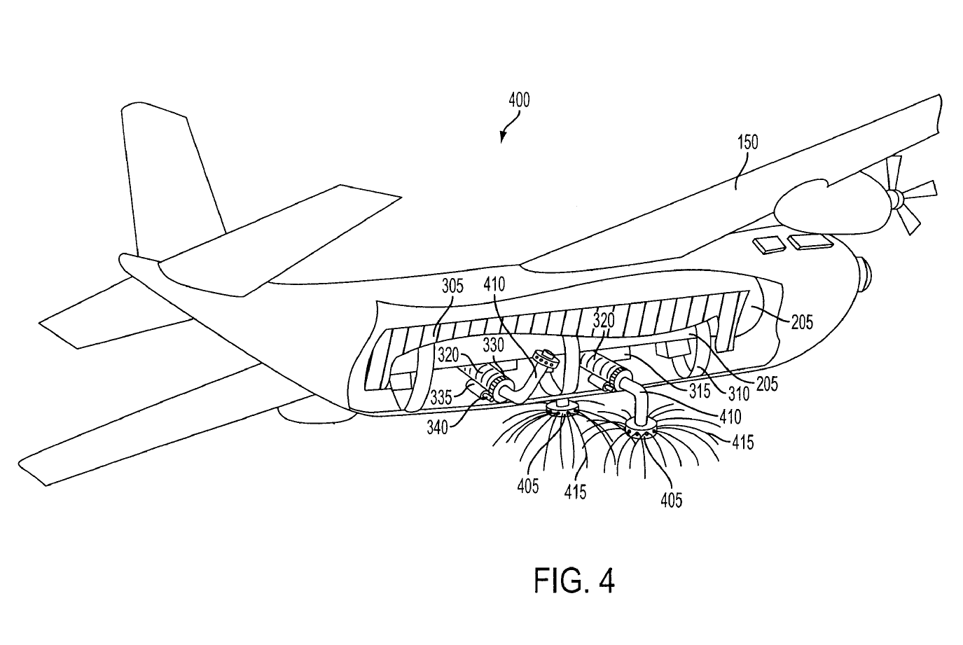

FIG. 4 shows a cargo airdrop system 400 according to an embodiment of the invention for an aircraft 150 at the drop point with its cargo doors 305 opened and a fixed insulated tank 205 containing the cryogenic liquid internal to the aircraft fuselage. In this embodiment, vapor is made by the evaporation of cryogenic liquid through heaters in “sprinkler” heads 405 at the exit ends of the delivery pipe assemblies 410. In the same manner as for the embodiment described in FIG. 3, the present embodiment allows the deployment of the delivery pipe assemblies 410 in or outside the confines of the aircraft. An external pipe assembly 410 with sprinkler head 405 is shown at a forward location on the aircraft and an internal pipe assembly 410 with sprinkler head 405 at an aft location on the aircraft. The cryogenic vapor spray for each of the paired heated sprinkler heads 405 along one manifold 320 is shown as 415 in the figure. For present day industrial use the tanks containing liquid air or liquid nitrogen are kept pressurized at about 250 psig which is enough pressure to allow the spraying activity required in this embodiment. This is not to say that this pressure could not be decreased or even increased if needed.

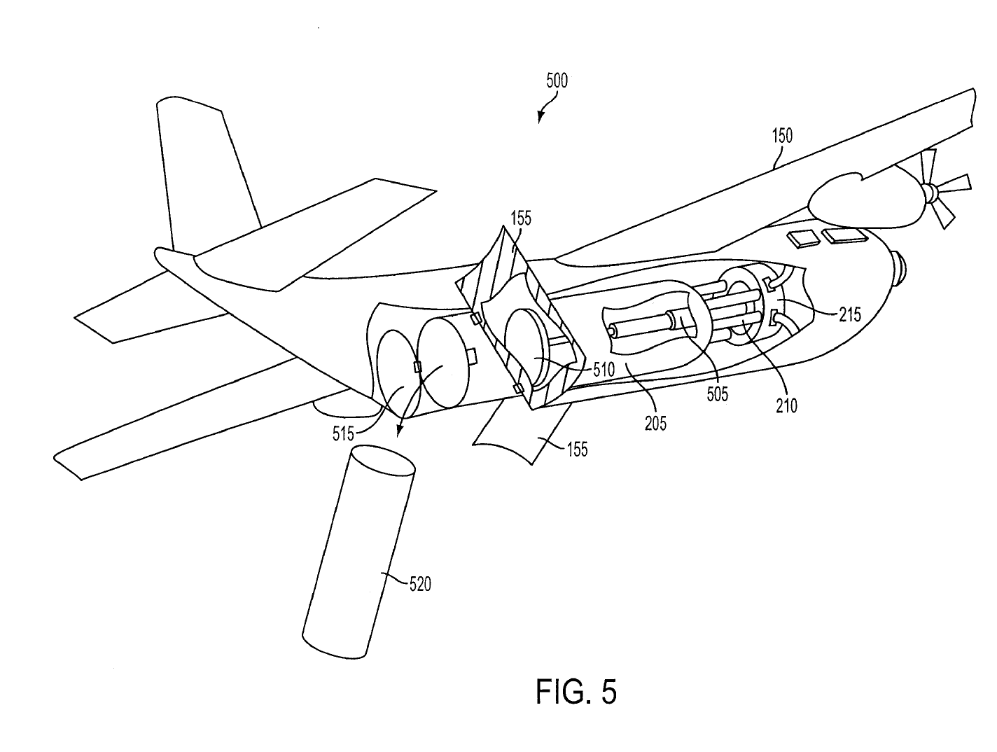

FIG. 5 shows a cargo airdrop system 500 according to an embodiment of the invention for an aircraft 150 at the drop point with its aft cargo doors 155 opened and an insulated tank 205 containing a cylindrical monolith of coolant solid 520 pushed aft on rails (not shown) internal to the aircraft fuselage. The coolant solid is made at the coolant manufacturing plant 130. A coolant solid can be transported in a similar tank as its liquid counterpart and dropped from the aircraft into the sidewall of the hurricane. In this embodiment, the cargo doors 155 aft of the aircraft are opened and the insulated tank containing the cryogenic solid pushed aft through the cargo door opening on rails within the aircraft. By means of the hydraulic pump assembly 215 the telescopic hydraulic assembly 210 pushes and retracts the insulated tank in or out for use as needed. The hydraulic pump assemble 215 also supplies activation to the longer telescopic hydraulic ram 505 attached to a piston 510 which ejects the cylindrical monolith of coolant 520 from the insulated tank 205. The door or hatch 515 is hydraulically actuated and made to open fully clear of the ejecting cylindrical solid monolith 520. The advantage over the liquid and vapor methods of cooling is that the large monolithic solid block 520 would fall to lower altitudes, possibly even impacting the surface of the ocean 110.

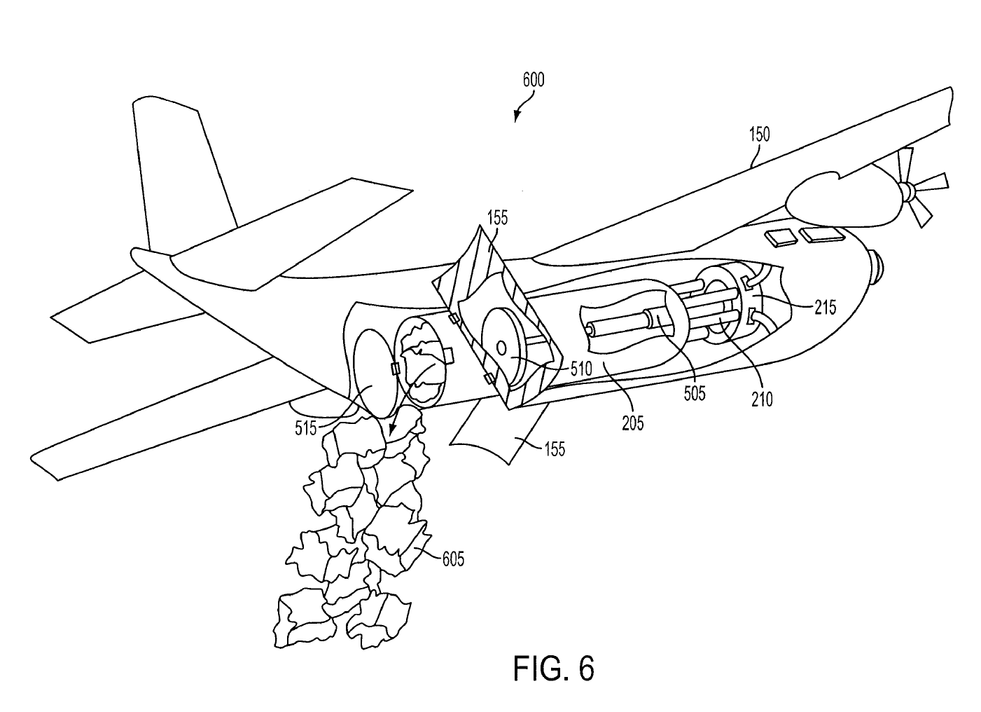

FIG. 6 shows a cargo airdrop system 600 according to an embodiment of the invention for an aircraft 150 at the drop point with its aft cargo doors 155 opened and an insulated tank 205 containing chunks of coolant solid 605 pushed aft on rails (not shown) internal to the aircraft fuselage. Such coolant solid chunks would be loaded into the same type of insulated container 205 as its liquid and monolithic solid counterparts and moved with the same hydraulically actuated piston 510 as for the monolithic cryogenic solid block. The use of smaller solid coolant geometries than for the monolith would offer further control on applying the coolant to a specific identified energy feeding region of an atmospheric disturbance whether it be a hurricane or not.

Identification of the energy feeding regions of an atmospheric disturbance can be accomplished through the use of the MM5 mesoscale model developed by the Pennsylvania State University Center for Atmospheric Research. See S. A. Braun et al. “High Resolution Simulation of Hurricane Bonnie (1998). Part 1: The Organization of Eyewall Vertical Motion.” Journal of the Atmospheric Sciences, Vol. 63, Issue 1, Pages 19-42, 2006, the disclosure of which is incorporated by reference herein in its entirety. This modeling study indicates that hurricanes have a moisture feeding mechanism in the form of thermal updrafts in the eye wall of the hurricane immediately surrounding the eye. It is not known for sure yet as to how many of these updrafts are present for hurricanes of different size. This is the subject of future modeling studies. However, the modeling studies indicate that new updrafts are formed at the downtilt-right side of the hurricane and intensify as they move cyclical around the eyewall until they reach the downtilt direction and then begin to weaken as they rotate around to the downtilt-left side. Therefore, a fruitful approach for abating a hurricane is not to randomly cool updrafts, but to cool downtilt-right side updrafts before they can intensify.

The present cooling methods will cause the condensation and solidification of moisture specifically in the updraft energy feeding regions of an atmospheric disturbance. The present invention, under certain conditions, will also create large solidified objects capable of decreasing the wind velocities in chosen regions of the atmospheric disturbance. In addition, solid coolant pieces of different size and weight are added to the updraft regions to cause wind shear at select altitudes. The altitude and dispersion of such frozen objects could be controlled so as not to cause physical damage over land masses. Over the ocean such objects could be allowed to impact the ocean surface without causing damage and would be environmentally benign objects in such a case. Cryogenic air coolant, in addition to being benign to the atmosphere does not perturb, outside of the moisture content, the normal ambient gaseous composition of the atmosphere in the region where it is applied. The material used for such cooling could be in the liquid, solid, or vapor forms depending on the desired effect.

In an embodiment of the invention, cryogenic liquid air is used as the cooling medium. This liquid would be transported in an airlift to the energy feeding region of an atmospheric disturbance from a land based liquid air plant. Liquid air and other cryogenic liquids are routinely manufactured by the Joule-Thompson expansion process. Cargo aircraft would transport the liquid air in insulated tanks (dewars) such as used for liquid nitrogen, liquid oxygen, liquid argon, or liquid hydrogen at semiconductor industrial facilities. There is no large industrial use for liquid air in these facilities or in industry, at large. This is because semiconductor fabrication requires the use of ultra pure inert and active gases with the ability to mix them in any combination desired for processing. Hospitals are obviously a large user of liquid oxygen not liquid air. The result is that liquid air is fractionated into liquid nitrogen, oxygen, and liquid argon and liquid air simply has zero use in industry since, if it is simply cooling which is required, and not chemical processing, then liquid nitrogen more than suffices for a cooling application. The abatement of atmospheric disturbances would be the first known application in which liquid air is the desired product.

The use of liquid air has the advantage of being a cooling medium which does not perturb the normal ambient gaseous composition of the atmosphere. Air liquefied from the earth's atmosphere at one locale is released to cool the atmospheric disturbance in another locale eventually becoming ambient temperature atmospheric air once more. The end result is an environmentally friendly treatment method. Liquid air is also a good choice of cryogenic coolant since the distillation of liquid air is presently routinely performed to obtain the products of liquid nitrogen, liquid oxygen, and liquid argon for industrial use. The distillation step would simply not be required in the present use for atmospheric disturbance abatement.

The liquid air would be released from the cargo aircraft either in a pour, in streams, or as a vapor. A pour comprises dropping the entire cargo load of liquid air into a chosen portion the atmospheric disturbance in one quick release. This would assure deeper penetration of the coolant to the lower altitudes.

In another embodiment of the invention a massive cylindrical solid monolithic block of air or smaller solid air pieces will be made by cooling selected volumes of liquid air with a separate Joule-Thompson expansion process manufacturing cryogenic gaseous hydrogen or helium. A closed loop cycle for manufacturing the cryogenic gaseous hydrogen or helium will be used since it is not necessary to use the hydrogen or helium coolant for any other purpose than heat exchanging with the product liquid air. Gaseous cryogenic hydrogen or helium, as opposed to their liquid counterparts, will be used, since the temperature difference between the liquefaction of the cryogenic gases to that of their solidification is not very different. For example, only 35 and 14 degrees Centigrade decreases in temperature are required to freeze liquid oxygen and liquid nitrogen, respectively. The required temperature difference between liquefied air and its solid is between these two values. Thus, although liquid neon at a boiling temperature of −246 degrees Centigrade, could be used to solidify even oxygen (the higher boiling point component of liquid air) the use of the cryogenic gases of hydrogen and helium are still recommended because of their known everyday use in industry and the known high thermal heat exchange of these particular gases.

The solid air would then be transported in an insulated tank similar to its liquid counterpart and dropped into a chosen portion of the atmospheric disturbance. The advantage is that the large solid block of air falls to lower altitudes than its liquid counterpart some of it possibly even falling to sea level. Smaller purposefully created pieces of solid air could be used to target certain predetermined altitudes in the energy feeding regions of an atmospheric disturbance. Thus, controlled cooling will be achieved both horizontally and vertically over the expanse of an atmospheric disturbance, an advantage over the methods of the prior art.

Another method of manufacturing solid air would be to rapidly vacuum pump on a volume of the liquid air. Smaller pieces of solid could be obtained by the rapid expansion of the liquid through a matrix of nozzles.

In the case of liquid air cooling, the heat extraction from the atmospheric disturbance would come from the heat of evaporation of the liquid air, and the heat extracted in heating the liquid air from its boiling temperature to that of the ambient temperature in the chosen region of the atmospheric disturbance. The latter cooling factor is by far the largest effect since a temperature difference of some 200 degrees Centigrade is involved coupled with the specific heat capacity of the large mass of liquid air. In the case of solid air, there would be an additional heat extraction due to the heat of fusion from the solid to the liquid form.

Another cryogenic liquid, solid and vapor which could be used for the present application are those of nitrogen. Liquid nitrogen is one of the distillates of the liquefaction of air process. It is in actuality, the largest percentage of distillate at about 78 percent. The use of cryogenic nitrogen, whether liquid, solid or vapor is not strictly a coolant which would leave the gaseous composition of the atmosphere where it is discharged unperturbed. In the drop zone, there would be a sudden increase in the nitrogen content of the ambient air which, over an unknown period of time, would dissipate and restore the naturally occurring gaseous composition of the atmosphere. However, such atmospheric perturbations occur worldwide at every industrial site where cryogenic liquids such as nitrogen, oxygen and argon are used as well as at the sites where such liquids are manufactured. In light of this, it would seem that the perturbation to the atmosphere in the limited seasonal use for hurricanes would be quite acceptable.

Aside from the cooling effect, the use of cryogenic liquids and solids such as air and nitrogen would have another significant effect on the abatement of atmospheric disturbances. The cryogenic liquid or solid would cause the moisture in the eyewall to coalesce and form ice. Control of the flow of vapor and liquid and the weight and size of the solids of these cryogenic materials makes it possible not just to coalesce small droplets of moisture or ice, as in the prior art, but to create large hailstones of significant mass. The presence of large hailstones would add to destabilizing the eye wall since the hurricane must perform work to move these ice objects. This results in a decrease in the wind speeds and an increase in wind sheer stresses which both add to reducing the intensity of the atmospheric disturbance.

Although carbon dioxide atmospheric disturbance cooling is not an environmentally benign process since such a gas is now known to cause global warming via the green house effect, its effects compared to the discharge of this chemical from other world sources would seem to represent a small impact on the environment given its limited use in the case of atmospheric disturbance abatement.

The invention has been described herein using specific embodiments for the purposes of illustration only. It will be readily apparent to one of ordinary skill in the art, however, that the principles of the invention can be embodied in other ways. The present embodiments do not preclude the cooling treatment of the sea surface in the calmer eye of the storm or the treatment of the area of most moisture entrapment where the region of the sea surface meets the eyewall of the hurricane. It also does not preclude the treatment of the hurricane from the highest altitudes down to sea level. In addition, the method and system herein described can be used for the abatement of any storm including, but not limited to hurricanes, typhoons, tropical storms, thunderstorms, rainstorms, and tornadoes. Therefore, the invention should not be regarded as being limited in scope to the specific embodiments of method and system or storms disclosed herein, but instead as being fully commensurate in scope with the following claims.

I claim:

1. A method for abating an atmospheric disturbance, the method comprising the steps of:
identifying an energy feeding region of an atmospheric disturbance,
delivering a coolant to said energy feeding region of said atmospheric disturbance, and
applying said coolant to said energy feeding region of said atmospheric disturbance.

2. The method of claim 1, wherein said identifying of said energy feeding region of said atmospheric disturbance is obtained from an analytical model of said atmospheric disturbance.

3. The method of claim 1, wherein said coolant is selected from the group consisting of: cryogenic liquid air, cryogenic air vapor, cryogenic solid air, cryogenic liquid nitrogen, cryogenic nitrogen vapor, cryogenic solid nitrogen, liquid carbon dioxide, carbon dioxide vapor, solid carbon dioxide (dry ice), cold liquid water, cold water vapor, and solid water (ice), and a combination thereof.

4. The method of claim 2, wherein said cryogenic air coolant is benign to the environment.

5. The method of claim 2, wherein said cryogenic air coolant does not perturb the normal ambient gaseous composition other than the moisture content in the region of the atmosphere to which it is applied.

6. The method of claim 1, wherein said atmospheric disturbance is selected from the group consisting of: a tropical depression, a tropical storm, a hurricane, a typhoon, a tornado, a rainstorm, a snow storm, a lightning storm, a warm frontal system, and a combination thereof.

7. The method of claim 1, wherein said step of delivering said coolant is by a vehicle selected from the group consisting of: an aircraft, a ship, a barge, a remotely controlled aircraft, a remotely controlled ship, a remotely controlled barge, and a combination thereof.

8. The method of claim 1, wherein said energy feeding region is a thermal updraft of said atmospheric disturbance.

9. The method of claim 8, wherein said energy feeding region is an initiating thermal updraft of said atmospheric disturbance.

10. The method of claim 8, wherein said initiating thermal updraft is a thermal updraft formed at the downtilt-right side of a hurricane.

11. The method of claim 1, wherein the target altitude of the delivery of said coolant is controlled by the choice of flow of vapor or liquid of said coolant.

12. The method of claim 1, wherein the target altitude of the delivery of said coolant is controlled by the weight of the pieces of the solid of said coolant

13. The system of claim 1, wherein said applying of said coolant is selected from the group consisting of: exposing, pouring, spraying, dropping, and a combination thereof.

14. A method for abating an atmospheric disturbance, the method comprising the steps of:
manufacturing a coolant, and
delivering said coolant to said atmospheric disturbance, and
applying said coolant to an energy feeding region of said atmospheric disturbance.

15. A method for abating an atmospheric disturbance comprising the steps of:
loading a cryogenic coolant onto a vehicle, and
delivering said vehicle loaded with said cryogenic coolant to said atmospheric disturbance.

16. The method of claim 15, wherein said vehicle is selected from the group consisting of: an aircraft, a ship, a barge, a remotely controlled aircraft, a remotely controlled ship, a remotely controlled barge, and a combination thereof.

17. A system comprising:
a delivery vehicle, and
a means for discharging a cryogenic coolant into an atmospheric disturbance.

18. The system of claim 17, wherein the delivery vehicle is selected from the group consisting of: an aircraft, a ship, a barge, a remotely controlled aircraft, a remotely controlled ship, a remotely controlled barge, and a combination thereof.

19. The system of claim 17, wherein said cryogenic coolant is selected from the group consisting of a cryogenic liquid, cryogenic vapor, cryogenic solid, and a combination thereof.
